(19) United States
(12) Patent Application Publication
(10) Pub. No.: US 2026/0120523 A1
(43) Pub. Date: Apr. 30, 2026

(54) WIRELESS VEHICLE DIAGNOSTIC DEVICE

(71) Applicant: Neal Parkman, Grand Prairie, TX (US)

(72) Inventor: Neal Parkman, Grand Prairie, TX (US)

(21) Appl. No.: 18/930,661

(22) Filed: Oct. 29, 2024

(51) Int. Cl. G07C 5/00; H04W 4/40

(52) U.S. Cl. CPC G07C 5/008; H04W 4/40; G07C 2205/02

(57) ABSTRACT

A wireless vehicle diagnostic device includes a personal electronic device in possession of a driver of a vehicle which is in wireless communication with an extrinsic communication network thereby enabling the personal electronic device to be in communication with a service technician who is remotely located with respect to the vehicle. A housing is provided and a data port is attached to the housing which is matable to a diagnostic port of the vehicle thereby enabling the data port to be in electrical communication with a diagnostic system of the vehicle. A transceiver is positioned within the housing and the transceiver is in wireless communication with the personal electronic device to enable the service technician to remotely access the diagnostic system of the vehicle.

### (B) CROSS-REFERENCE TO RELATED APPLICATIONS

### Not Applicable

### (C) STATEMENT REGARDING FEDERALLY SPONSORED RESEARCH OR DEVELOPMENT

### Not Applicable

### (D) THE NAMES OF THE PARTIES TO A JOINT RESEARCH AGREEMENT

### Not Applicable

### (E) INCORPORATION-BY-REFERENCE OF MATERIAL SUBMITTED ON A COMPACT DISC OR AS A TEXT FILE VIA THE OFFICE ELECTRONIC FILING SYSTEM

### Not Applicable

### (F) STATEMENT REGARDING PRIOR DISCLOSURES BY THE INVENTOR OR JOINT INVENTOR

### Not Applicable

### (G) BACKGROUND OF THE INVENTION

### (1) Field of the Invention

The disclosure relates to vehicle diagnostic devices and more particularly pertains to a new vehicle diagnostic device for enabling a service technician to remotely access a diagnostic system of a vehicle. The device includes a housing and a data port attached to the housing that is matable to a diagnostic port of a vehicle. The device includes a transceiver positioned in the housing that is in wireless communication with a personal electronic device which is in possession of a driver of the vehicle. The personal electronic device is in wireless communication with an extrinsic communication network to enable a service technician to remotely access a diagnostic system of the vehicle.

### (2) Description of Related Art Including Information Disclosed Under 37 CFR 1.97 and 1.98

The prior art relates to vehicle diagnostic devices including a variety of vehicle diagnostic devices that each at least includes a means of wireless communication between an electrical system of a vehicle and a service center for enabling remote access to a diagnostic system of the vehicle. In no instance does the prior art disclose a wireless vehicle diagnostic device that includes a housing and a data port attached to the housing which is matable to a diagnostic port of a vehicle and a transceiver positioned in the housing that is in wireless communication with a personal electronic device which is in wireless communication with an extrinsic communication network to enable a service technician to remotely access a diagnostic system of the vehicle.

### (H) BRIEF SUMMARY OF THE INVENTION

An embodiment of the disclosure meets the needs presented above by generally comprising a personal electronic device in possession of a driver of a vehicle which is in wireless communication with an extrinsic communication network thereby enabling the personal electronic device to be in communication with a service technician who is remotely located with respect to the vehicle. A housing is provided and a data port is attached to the housing which is matable to a diagnostic port of the vehicle thereby enabling the data port to be in electrical communication with a diagnostic system of the vehicle. A transceiver is positioned within the housing and the transceiver is in wireless communication with the personal electronic device to enable the service technician to remotely access the diagnostic system of the vehicle.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (I) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a wireless vehicle diagnostic device according to an embodiment of the disclosure.

FIG. 2 is an exploded perspective view of an embodiment of the disclosure showing a data port being mated to a diagnostic port.

FIG. 3 is a phantom perspective view of an embodiment of the disclosure.

FIG. 4 is a perspective in-use view of an embodiment of the disclosure.

FIG. 5 is a schematic view of an embodiment of the disclosure.

### (J) DETAILED DESCRIPTION OF THE INVENTION

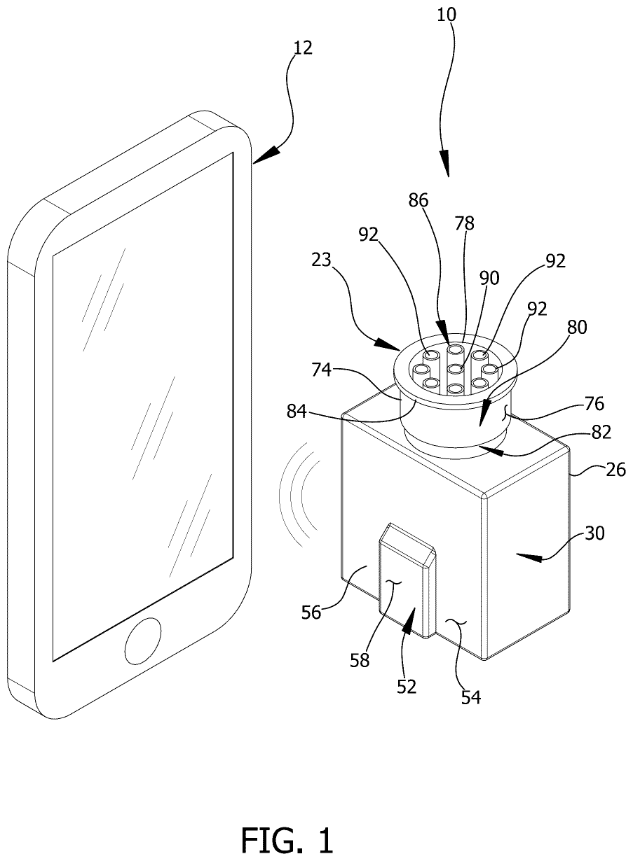

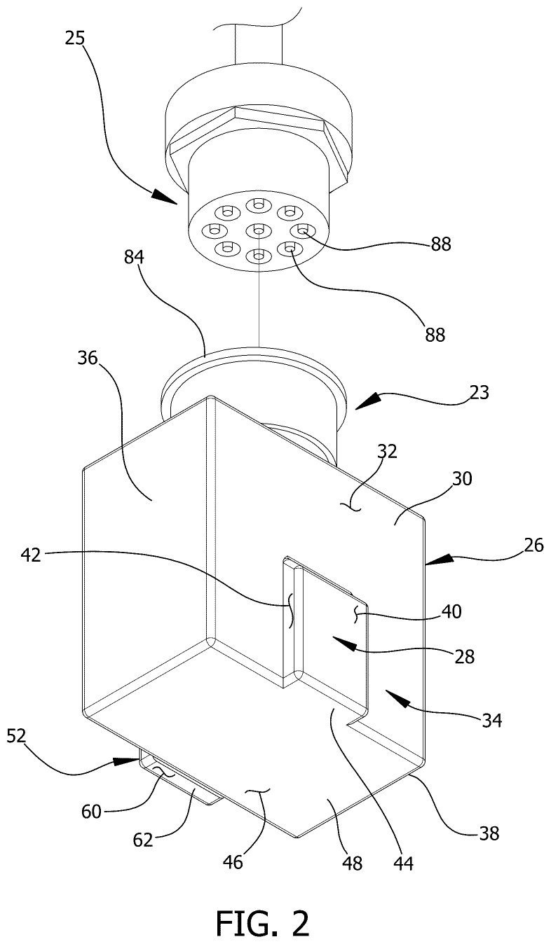

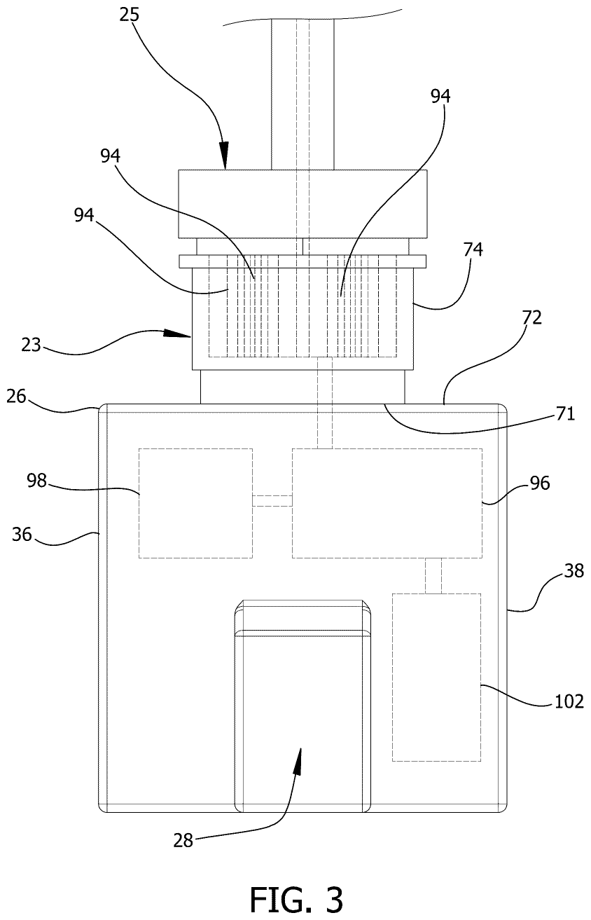

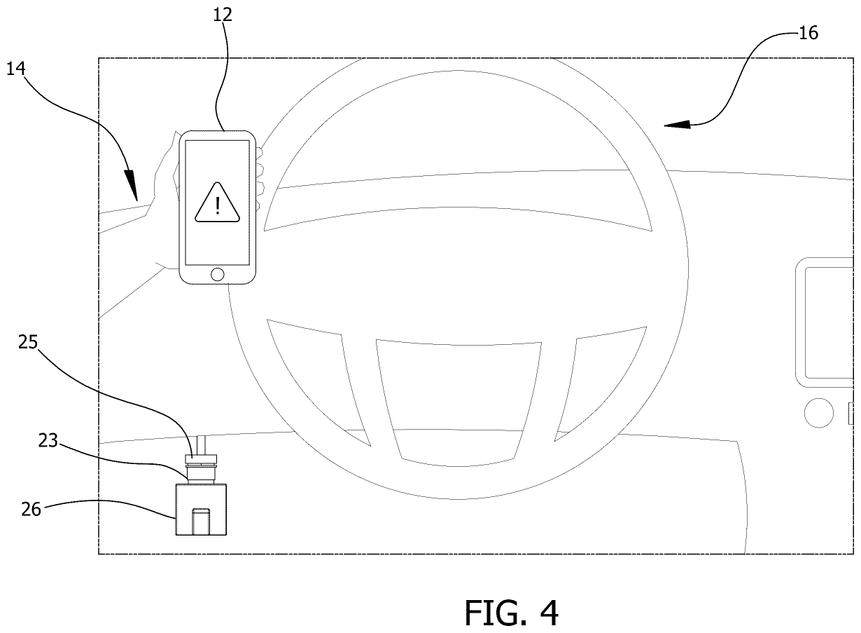

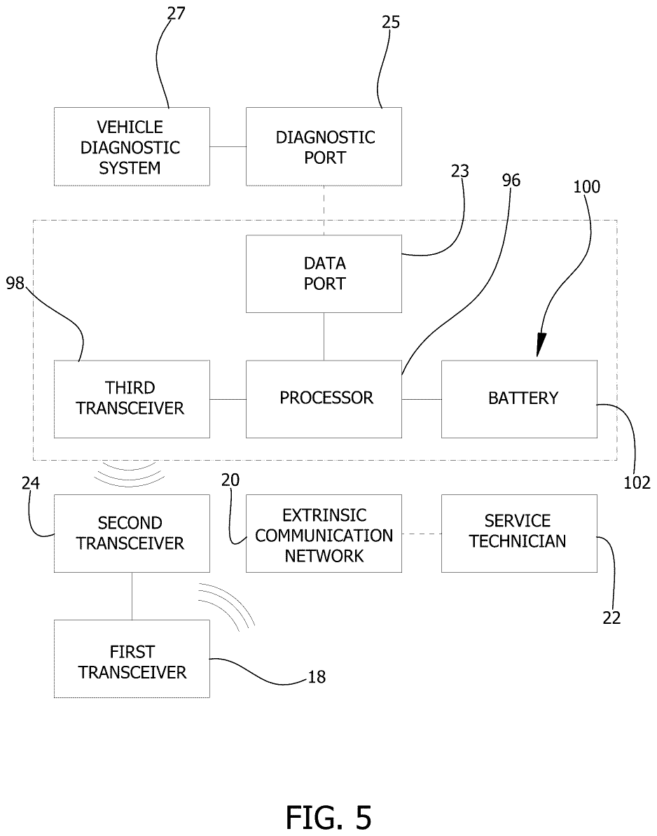

With reference now to the drawings, and in particular to FIGS. 1 through 5 thereof, a new vehicle diagnostic device embodying the principles and concepts of an embodiment of the disclosure and generally designated by the reference numeral 10 will be described.

As best illustrated in FIGS. 1 through 5, the wireless vehicle diagnostic device 10 generally comprises a personal electronic device 12 which is in possession of a driver 14 of a vehicle 16. The personal electronic device 12 may be a smart phone or other type of electronic device that has wireless communication capabilities and the vehicle 16 may be a semi tractor or other type of diesel powered vehicle. A first transceiver 18 is provided and the first transceiver 18 is positioned within the personal electronic device 12. The first transceiver 18 is in wireless communication with an extrinsic communication network 20 thereby enabling the personal electronic device 12 to be in communication with a service technician 22 who is remotely located with respect to the vehicle 16. The extrinsic communication network 20 may comprise a cellular phone network or the internet or other type of wireless communication network that enables global communication. The first transceiver 18 may comprise a radio transceiver or the like and the first transceiver 18 may employ cellular phone communication protocols or a WPAN signal. A second transceiver 24 is positioned within the personal electronic device 12 and the second transceiver 24 is in electronic communication with the first transceiver 18 thereby enabling the second transceiver 24 to be in communication with the extrinsic communication network 20. Additionally, the second transceiver 24 may comprise a radio frequency transceiver or the like and the second transceiver 24 may employ Bluetooth communication protocols.

A housing 26 is provided and a data port 23 is attached to the housing 26. The data port 23 can be mated to a diagnostic port 25 of the vehicle 16 thereby enabling the data port 23 to be in electrical communication with a diagnostic system 27 of the vehicle 16. A first prominence 28 extends outwardly from an outer wall 30 of the housing 26 to enhance the driver's 14 ability to grip the housing. The first prominence 28 extends away from an outer surface 32 of a front side 34 of the outer wall 30 and the first prominence 28 is centrally located between a first lateral side 36 and a second lateral side 38 of the outer wall 30. Additionally, the first prominence 28 has an outwardly facing surface 40 which lies on a plane that is oriented parallel to the outer surface 32 of the front side 34 of the outer wall 30. The first prominence 28 has an exterior surface 42 extending between the outwardly facing surface 40 and the outer surface 32 of the front side 34.

Furthermore, the exterior surface 42 has a lower side 44 which lies on a plane that is oriented coplanar with a bottom surface 46 of a bottom wall 48 of the housing 26. The lower side 44 enables the driver 14 to urge the housing 26 upwardly to mate the data port 23 to the diagnostic port 25.

A second prominence 52 extends outwardly from the outer wall 30 of the housing 26 to enhance the driver's 14 ability to grip the housing 26. The second prominence 52 extends away from an outer surface 54 of a back side 56 of the outer wall 30 and the second prominence 52 is centrally located between the first lateral side 36 and the second lateral side 38 of the outer wall 30. The second prominence 52 has an outwardly facing surface 58 of the second prominence 52 which lies on a plane that is oriented parallel to the outer surface 54 of the back side 56 of the outer wall 30. Additionally, the second prominence 52 has an outside surface 60 extending between the outwardly facing surface 58 of the second prominence 52 and the outer surface 32 of the back side 56. Furthermore, the outside surface 60 has a lowermost side 62 which lies on a plane that is oriented coplanar with the bottom surface 46 of the bottom wall 48 of the housing 26. The lowermost side 62 enables the driver 14 to urge the housing 26 upwardly to mate the data port 23 to the diagnostic port 25.

The data port 23 has a bottom wall 71 which is coupled to a top wall 72 of the housing 26 and the data port 23 has a perimeter wall 74 extending upwardly from the bottom wall 71 of the data port 23. The perimeter wall 74 is continuously arcuate about a center of the bottom wall 71 of the data port 23 such that the data port 23 has a cylindrical shape. In this way the data port 23 can conform to the shape of the diagnostic port 25 thereby enabling the data port 23 to be matable to the diagnostic port 25 of the vehicle 16.

The perimeter wall 74 has an exterior surface 76 extending between a top edge 78 of the perimeter wall 74 and the bottom wall 71 of the data port 23 and the exterior surface 76 has a top portion 80 which has a diameter that is greater than a bottom portion 82 of the exterior surface 76. The top portion 80 is associated with the top edge 78 of the perimeter wall 74 and the bottom portion 82 is associated with the bottom wall 48. Additionally, the perimeter wall 74 has a lip 84 which is perpendicular to the top portion 80 of the exterior surface 76 and the lip 84 is aligned with the top edge 78 of the perimeter wall 74.

A plurality of tubes 86 is provided and each tube 86 of the plurality of tubes 86 is coupled to and extends upwardly from the bottom wall 71 of the data port 23 such that the perimeter wall 74 of the data port 23 surrounds the plurality of tubes 86. In this way each tube 86 of the plurality of tubes 86 insertably receives a respective contact 88 of a plurality of contacts 88 of the diagnostic port 25 when the data port 23 is mated to the diagnostic port 25. The plurality of tubes 86 includes a central tube 90 and a plurality of outer tubes 92 of the plurality of tubes 86. Additionally, the plurality of outer tubes 92 is radially distributed around the central tube 90.

A plurality of data contacts 94 is provided and each data contact 94 of the plurality of data contacts 94 is positioned within a respective tube 86 of the plurality of tubes 86. Each data contact 94 of the plurality of data contacts 94 is comprised of an electrically conductive material. In this way each data contact 94 of the plurality of data contacts 94 is placed in electrical communication with a respective contact 88 in the diagnostic port 25 when the data port 23 is mated to the diagnostic port 25. A processor 96 is positioned within the housing 26 and each data contact 94 of the plurality of data contacts 94 is in electrical communication with the processor 96. In this way the processor 96 is placed in electrical communication with the diagnostic system 27 of the vehicle 16 when the data port 23 is mated to the diagnostic port 25 of the vehicle 16.

A third transceiver 98 is positioned within the housing 26 and the third transceiver 98 is in electrical communication with the processor 96. Furthermore, the third transceiver 98 is in wireless communication with the second transceiver 24. In this way the third transceiver 98 enables the service technician 22 to remotely access the diagnostic system 27 of the vehicle 16 via the extrinsic communication network 20 when the data port 23 is mated to the diagnostic port 25 of the vehicle 16. The third transceiver 98 may comprise a radio frequency transceiver or the like and the third transceiver 98 may employ Bluetooth communication protocols. A power supply 100 is positioned within the housing 26, the power supply 100 is in electrical communication with the processor 96 and the power supply 100 comprises at least one battery 102. The at least one battery 102 might be accessible through a battery cover that is removably attached to the outer wall 30 of the housing 26 for removing and replacing the at least one battery 102.

In use, the data port 23 is mated to the diagnostic port 25 in the vehicle 16 when the vehicle 16 experiences a malfunction while the vehicle 16 is being driven. The personal electronic device 12 is wirelessly connected to the third transceiver 98, via a Bluetooth connection, to enable the service technician 22 to wireless access the diagnostic system 27 in the vehicle 16 via the extrinsic communication network 20. In this way the service technician 22 can access fault codes that are stored in the diagnostic system 27 of the vehicle 16 and potentially reset the fault codes to enable the vehicle 16 to continue to be driven. In this way an over the road truck driver, for example, can potentially avoid the need of having the vehicle 16 towed to a service center for repairs or diagnosis. Additionally, the personal electronic device 12 might store a smartphone application that includes contact information for authorized service centers that the driver 14 can contact to enable the service technician 22 to remotely access the diagnostic system 27.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A wireless vehicle diagnostic device for enabling a service technician to remotely access a diagnostic system of a vehicle, said device comprising:
a personal electronic device being configured to be in possession of a driver of the vehicle;
a first transceiver being positioned within said personal electronic device wherein said first transceiver is configured to be in wireless communication with an extrinsic communication network thereby enabling said personal electronic device to be in communication with a service technician who is remotely located with respect to the vehicle;
a second transceiver being positioned within said personal electronic device, said second transceiver being in electrical communication with said first transceiver wherein said second transceiver is configured to be in communication with the extrinsic communication network;
a housing;
a first prominence extending outwardly from an outer wall of said housing wherein said first prominence is configured to enhance the driver's ability to grip said housing;
a second prominence extending outwardly from said outer wall of said housing wherein said second prominence is configured to enhance the driver's ability to grip said housing;
a data port being attached to said housing wherein said data port is configured to be mated to a diagnostic port of the vehicle thereby enabling said data port to be in electrical communication with a diagnostic system of the vehicle;
a processor being positioned within said housing, said processor being in electrical communication with said data port wherein said processor is configured to be in electrical communication with the diagnostic system of the vehicle when said data port is mated to the diagnostic port of the vehicle; and
a third transceiver being positioned within said housing, said third transceiver being in electrical communication with said processor, said third transceiver being in wireless communication with said second transceiver wherein said third transceiver is configured to enable the service technician to remotely access the diagnostic system of the vehicle via the extrinsic communication network when said data port is mated to the diagnostic port of the vehicle.

2. The wireless vehicle diagnostic device according to claim 1, wherein:
said first prominence extends away from an outer surface of a front side of said outer wall of said housing; and
said first prominence is centrally located between a first lateral side and a second lateral side of said outer wall.

3. The wireless vehicle diagnostic device according to claim 2, wherein said first prominence has an outwardly facing surface lying on a plane being oriented parallel to said outer surface of said front side of said outer wall.

4. The wireless vehicle diagnostic device according to claim 3, wherein:
said first prominence has an exterior surface extending between said outwardly facing surface and said outer surface of said front side; and
said exterior surface has a lower side which lies on a plane being oriented coplanar with a bottom surface of a bottom wall of said housing wherein said lower side is configured to enable to driver to urge said housing upwardly to mate said data port to the diagnostic port.

5. The wireless vehicle diagnostic device according to claim 1, wherein:
said second prominence extends away from an outer surface of a back side of said outer wall of said housing; and
said second prominence is centrally located between said first lateral side and said second lateral side of said outer wall.

6. The wireless vehicle diagnostic device according to claim 5, wherein said second prominence has an outwardly facing surface of said second prominence lying on a plane being oriented parallel to said outer surface of said back side of said outer wall.

7. The wireless vehicle diagnostic device according to claim 5, wherein:
said second prominence has an outside surface extending between said outwardly facing surface of said second prominence and said outer surface of said back side; and
said outside surface has a lowermost side which lies on a plane being oriented coplanar with a bottom surface of a bottom wall of said housing wherein said lowermost side is configured to enable the driver to urge said housing upwardly to mate said data port to the diagnostic port.

8. The wireless vehicle diagnostic device according to claim 1, wherein said data port has a bottom wall being coupled to a top wall of said housing.

9. The wireless vehicle diagnostic device according to claim 8, wherein:
said data port has a perimeter wall extending upwardly from said bottom wall of said data port; and
said perimeter wall is continuously arcuate about a center of said bottom wall of said data port such that said data port has a cylindrical shape wherein said data port is configured to be matable to the diagnostic port of the vehicle.

10. The wireless vehicle diagnostic device according to claim 9, wherein:
said perimeter wall having an exterior surface extending between a top edge of said perimeter wall and said bottom wall of said data port;
said exterior surface has a top portion which has a diameter being greater than a bottom portion of said exterior surface;
said top portion is associated with said top edge of said perimeter wall; and
said bottom portion is associated with said bottom wall.

11. The wireless vehicle diagnostic device according to claim 10, wherein:
said perimeter wall has a lip being perpendicular to said top portion of said exterior surface; and
said lip is aligned with said top edge of said perimeter wall.

12. The wireless vehicle diagnostic device according to claim 9, wherein:
said wireless vehicle diagnostic device includes a plurality of tubes; and
each tube of said plurality of tubes is coupled to and extends upwardly from said bottom wall of said data port such that said perimeter wall of said data port surrounds said plurality of tubes wherein each tube of said plurality of tubes is configured to insertably receive a respective contact of a plurality of contacts of the diagnostic port when said data port is mated to the diagnostic port.

13. The wireless vehicle diagnostic device according to claim 12, wherein:
said plurality of tubes includes a central tube of said plurality of tubes and a plurality of outer tubes of said plurality of tubes; and
said plurality of outer tubes is radially distributed around said central tube.

14. The wireless vehicle diagnostic device according to claim 12, wherein:
said device includes a plurality of data contacts; and
each data contact of said plurality of data contacts is positioned within a respective tube of said plurality of tubes.

15. The wireless vehicle diagnostic device according to claim 14, wherein each data contact of said plurality of data contacts is comprised of an electrically conductive material wherein each data contact of said plurality of data contacts is configured to be in electrical communication with a respective contact in the diagnostic port when said data port is mated to the diagnostic port.

16. The wireless vehicle diagnostic device according to claim 14, wherein each data contact of said plurality of data contacts being in electrical communication with said processor.

17. A wireless vehicle diagnostic device for enabling a service technician to remotely access a diagnostic system of a vehicle, said device comprising:
a personal electronic device being configured to be in possession of a driver of the vehicle;
a first transceiver being positioned within said personal electronic device wherein said first transceiver is configured to be in wireless communication with an extrinsic communication network thereby enabling said personal electronic device to be in communication with a service technician who is remotely located with respect to the vehicle;
a second transceiver being positioned within said personal electronic device, said second transceiver being in electrical communication with said first transceiver wherein said second transceiver is configured to be in communication with the extrinsic communication network;
a housing;
a data port being attached to said housing wherein said data port is configured to be mated to a diagnostic port of the vehicle thereby enabling said data port to be in electrical communication with an diagnostic system of the vehicle;
a first prominence extending outwardly from an outer wall of said housing wherein said first prominence is configured to enhance the driver's ability to grip said housing, said first prominence extending away from an outer surface of a front side of said outer wall, said first prominence being centrally located between a first lateral side and a second lateral side of said outer wall, said first prominence having an outwardly facing surface lying on a plane being oriented parallel to said outer surface of said front side of said outer wall, said first prominence having an exterior surface extending between said outwardly facing surface and said outer surface of said front side, said exterior surface having a lower side which lies on a plane being oriented coplanar with a bottom surface of a bottom wall of said housing wherein said lower side is configured to enable the driver to urge said housing upwardly to mate said data port to the diagnostic port;
a second prominence extending outwardly from said outer wall of said housing wherein said second prominence is configured to enhance the driver's ability to grip said housing, said second prominence extending away from an outer surface of a back side of said outer wall, said second prominence being centrally located between said first lateral side and said second lateral side of said outer wall, said second prominence having an outwardly facing surface of said second prominence lying on a plane being oriented parallel to said outer surface of said back side of said outer wall, said second prominence having an outside surface extending between said outwardly facing surface of said second prominence and said outer surface of said back side, said outside surface having a lowermost side which lies on a plane being oriented coplanar with said bottom surface of said bottom wall of said housing wherein said lowermost side is configured to enable the driver to urge said housing upwardly to mate said data port to the diagnostic port;
said data port having a bottom wall being coupled to a top wall of said housing, said data port having a perimeter wall extending upwardly from said bottom wall of said data port, said perimeter wall being continuously arcuate about a center of said bottom wall of said data port such that said data port has a cylindrical shape wherein said data port is configured to be matable to the diagnostic port of the vehicle, said perimeter wall having an exterior surface extending between a top edge of said perimeter wall and said bottom wall of said data port, said exterior surface having a top portion which has a diameter being greater than a bottom portion of said exterior surface, said top portion being associated with said top edge of said perimeter wall, said bottom portion being associated with said bottom wall, said perimeter wall having a lip being perpendicular to said top portion of said exterior surface, said lip being aligned with said top edge of said perimeter wall;
a plurality of tubes, each tube of said plurality of tubes being coupled to and extending upwardly from said bottom wall of said data port such that said perimeter wall of said data port surrounds said plurality of tubes wherein each tube of said plurality of tubes is configured to insertably receive a respective contact of a plurality of contacts of the diagnostic port when said data port is mated to the diagnostic port, said plurality of tubes including a central tube of said plurality of tubes and a plurality of outer tubes of said plurality of tubes, said plurality of outer tubes being radially distributed around said central tube;
a plurality of data contacts, each data contact of said plurality of data contacts being positioned within a respective tube of said plurality of tubes, each data contact of said plurality of data contacts being comprised of an electrically conductive material wherein each data contact of said plurality of data contacts is configured to be in electrical communication with a respective contact in the diagnostic port when said data port is mated to the diagnostic port;
a processor being positioned within said housing, each data contact of said plurality of data contacts being in electrical communication with said processor wherein said processor is configured to be in electrical communication with the diagnostic system of the vehicle when said data port is mated to the diagnostic port of the vehicle;
a third transceiver being positioned within said housing, said third transceiver being in electrical communication with said processor, said third transceiver being in wireless communication with said second transceiver wherein said third transceiver is configured to enable the service technician to remotely access the diagnostic system of the vehicle via the extrinsic communication network when said data port is mated to the diagnostic port of the vehicle; and
a power supply being positioned within said housing, said power supply being in electrical communication with said processor, said power supply comprising at least one battery.
